(19) United States
(12) Patent Application Publication
(10) Pub. No.: US 2020/0375216 A1
(43) Pub. Date: Dec. 3, 2020

(54) SYSTEM FOR CRYOGENIC FREEZING OF VISCOUS FEED

(71) Applicant: DIPPIN' DOTS CRYOGENICS, L.L.C., OKLAHOMA CITY, OK (US)

(72) Inventor: Stan JONES, Vienna, IL (US)

(21) Appl. No.: 16/765,014

(22) PCT Filed: Dec. 5, 2018
(86) PCT No.: PCT/US2018/064092

§ 371 Date: May 18, 2020

Related U.S. Application Data
(60) Provisional application No. 62/607,182, filed on Dec. 18, 2017.

(51) Int. Cl. A23G 9/52; A23L 3/375

(52) U.S. Cl. CPC A23G 9/52; A23L 3/362; A23L 3/375

(57) ABSTRACT

A free-flowing frozen pellet product produced from a paste, which has a viscosity of at least 200 Cp, is produced by a system and product. The system and product include introducing the paste into an enclosed feed tray. The paste is introduced at a pressure above atmospheric pressure and remains above atmospheric pressure while in the enclosed feed tray. Subsequently, the paste is extruded out of the enclosed feed tray through a plurality of projections to produce a plurality of pellets. The pellets are passed through a cryogenic chamber to thus freeze the pellets at subzero temperatures to produce frozen pellets.

### CROSS REFERENCE TO RELATED APPLICATION

This application claims the benefit of U.S. Provisional Patent Application No. 62/607,182 filed on Dec. 18, 2017.

### FIELD

The present disclosure relates generally to the field of frozen foods, and more specifically, to the preparation of such frozen products from viscous feeds.

### BACKGROUND

Cryogenic freezing has been applied to liquid products, such as ice cream mixes. For example, U.S. Pat. No. 5,126,156, issued Jun. 30, 1992, describes a method involving delivering flavored liquid dairy composition to a feed tray and then dripping the composition into a freezing chamber. The feed tray comprises a sieve plate having orifices formed therein. The liquid dairy composition passes through the sieve plate and forms droplets that fall into the freezing chamber. The falling droplets of liquid composition freeze rapidly in the freezing chamber, forming solid beads of flavored ice cream or yogurt product. The frozen beads are removed from the freezing chamber and packed for distribution and later consumption.

While such cryogenic process has been suitable for freezing low viscosity liquids (typically less than about 150 Cp at the introductory temperature to the feed tray), they cannot handle higher viscosity liquids or pastes such as cream cheese, custard, chocolate and citrus fruit pulp. If such pastes are used in traditional processes for making frozen beads, the pastes build up in the tray and eventually create a frozen mass that prevents any pass through.

On the other hand, frozen pellet products of these pastes could be highly useful both as a novelty product and as means of transporting and using such pastes so as to avoid spoilage. Accordingly, a need is identified to create frozen pellet products of these pastes.

### SUMMARY

Some embodiments of this disclosure are directed to a free-flowing frozen pellet produced from a paste having a viscosity from 200 Cp to 30,000 Cp at processing temperatures. In some of these embodiments, the viscosity is from 500 Cp to 20,000 Cp or from 1000 Cp to 10,000 Cp at processing temperatures. In the embodiments, the processing temperature is generally from about 32° F. to about 100° F., but more typically from 32° F. to 45° F. Generally, the paste has been pelletized to a diameter of less than 40 mm, and the paste is frozen at temperatures of less than −100° F. to produce the free-flowing frozen pellet.

In other embodiments, there is provided a process for the paste to form the free-flowing frozen pelletized product. The process typically comprises:
introducing the paste into an enclosed feed tray, wherein the paste is introduced at a pressure above atmospheric pressure and remains above atmospheric pressure while in the enclosed feed tray, wherein the paste has a viscosity above about 200 Cp;
extruding the paste out of the enclosed feed tray through a plurality of projections so as to produce a plurality of pellets; and
passing the pellets through a cryogenic chamber to thus freeze the pellets at subzero temperatures to produce frozen pellets.

The paste can be extruded out of the enclosed feed tray through a plurality of projections and the process can further comprise cutting the paste as the paste is extruded out of the enclosed feed tray by a cutter operatively associated with projections.

In some embodiments, the enclosed feed tray is divided into a plurality of partitions, which are isolated so that paste is not flowing between partitions. In such embodiments, the introduction of the paste into an enclosed feed tray can further comprise introducing a first paste into at least one of the partitions and a second paste into a least one of the other partitions. In these embodiments, the process can produce a first portion of the pellets consisting essentially of the first paste and a second portion of the pellets consisting essentially of the second paste.

Typically in the above embodiments, the pressure of the paste is at least 1 psig within the enclosed feed tray, and can be at least 2 psig, at least 5 psig or even at least 10 psig.

Still other embodiments are directed to a system configured to carry out the process and produce the free-flowing frozen pellets. The system comprises the enclosed feed tray, and the cryogenic freezing chamber. However, in some embodiments, the system also comprises one or more paste sources and one or more pumps. Still further embodiments include a cutter.

The enclosed feed tray is pressurized above atmospheric pressure. The enclosed feed tray having at least one entrance port through which the paste is introduced into the tray at a pressure above atmospheric pressure, and a plurality of projections through which the paste is extruded out of the tray.

The cryogenic freezing chamber configured to receive the paste extruded from the plurality of projections. The paste is introduced into the cryogenic freezing chamber as a plurality of pellets, and the cryogenic freezing chamber is configured to cryogenically freeze the pellets such that the pellets are frozen to subzero temperatures as the first pellets fall through the cryogenic freezing chamber.

When included, the cutter can be operatively associated with the projections so as to cut paste extruded through the projections thus producing the pellets.

When one or more sources of paste and one or more pumps are included, the pump is in fluid flow communication with the source and with the entrance port so as to introduce paste from the source to the enclosed feed tray at the pressure above atmospheric pressure.

The enclosed feed tray can be divided into two or more partitions which are isolated so that paste does not flow between partitions. When so divided, the tray can further comprise two or more entrance ports such that there is at least one entrance port associated with each partition. Accordingly, the paste can comprise at least a first paste and a second paste, and the system can be configured so that the first paste is provided to at least one of the partitions and the second paste is provided to at least one of the other partitions. The system can then produce a first portion of the pellets consisting essentially of the first paste and a second portion of the pellets consisting essentially of the second paste.

### BRIEF DESCRIPTION OF THE DRAWINGS

The foregoing summary as well as the following detailed description of the preferred embodiments of the present invention will be better understood when reviewed in conjunction with the appended drawings. It should be understood that the invention is not limited to the precise arrangements and instrumentalities shown. Further, the components in the drawings are not necessarily to scale, emphasis instead is placed upon clearly illustrating the principles of the present invention. Moreover, in the drawings, like reference numerals designate corresponding parts throughout the several views. In the drawings:

FIG. 1 is a schematic illustration of one embodiment of a device for forming frozen pellet product from pastes.

FIG. 2 is a top view of a tray with a pressure lid, which is useful in the embodiment of FIG. 1.

FIG. 3 is a top view of the tray of FIG. 2 without a pressure lid.

FIG. 4 is a schematic illustration of a second embodiment of a device for forming frozen pellet product from pastes. This second embodiment uses a cutter to break up ribbons of paste.

FIG. 5 is a bottom view of a tray using a cutter in accordance with FIG. 4.

FIG. 6 is a cross-sectional view of an enlarged portion of the tray and cutter shown in FIG. 4.

### DETAILED DESCRIPTION

The present disclosure may be understood more readily by reference to the following detailed description and figures. In addition, numerous specific details are set forth in order to provide a thorough understanding of the embodiments described herein. However, those of ordinary skill in the art will understand that the embodiments described herein can be practiced without these specific details. In other instances, methods, procedures and components have not been described in detail so as not to obscure the related relevant feature being described.

This disclosure concerns apparatuses and methods of making frozen products out of pastes. As used herein, “paste” or “pastes” refer to liquids having a viscosity above about 200 Cp and more typically above about 300 Cp, 500 Cp or 1000 Cp, where the viscosity is for the pre-frozen paste at processing temperatures. “Processing temperatures” refer to normal safe handling temperatures for the paste. For food products, the processing temperatures of the paste will be at temperatures suitable for safe handling of food—generally, regeneration temperatures of about 32° F. to about 45° F. but for some food products, the processing temperature range can be more broadly 32° F. to about 70° F. For non-food product paste the processing temperature can be broader but typically will be above 32° F. and is generally below 100° F.

Generally, the disclosed apparatuses and methods apply best to pastes having a viscosity of about 30,000 Cp or less, more typically, about 20,000 Cp or less, or 10,000 Cp or less at processing temperatures. While generally, the paste discussed herein will be food products, the disclosed apparatus and methods have wider applications and can apply to pastes which are not food products. With regard to food product paste, this disclosure has application to food product paste having a viscosity from 200 Cp to 30,000 Cp. For example, the food product paste herein can be cream cheese, custard, chocolate and citrus fruit pulp, and the disclosure particularly relates to cream cheese. Cream cheese generally has a processing temperature of about 32° F. to about 45° F.

Generally, the frozen product made from the paste will be in a frozen pellet form. As is further explained below, the paste can be divided into small pellets, typically as the paste is introduced into a cryogenic freezer. The pellets are flash frozen in a cryogenic freezer. The resultant frozen pellets are small pellets, which can be small rounded masses, elongated masses or ribbons. Generally, if the pellet is a small rounded mass, it will have a roughly spherical shape with a diameter of from about 5 mm to about 40 mm, more typically from about 10 mm to about 30 mm, and often from about 15 mm to about 20 mm. Typically, the pellets will have some variation in size, thus if the pellets are to be 20 mm in size they might range from 15 mm to 25 mm but could range from 17 mm to 23 mm, 18 mm to 22 mm, or 19 mm to 21 mm.

Generally, if the pellet is an elongated mass or ribbon, it will have a roughly cylindrical shape. With the restriction that the length is longer than the diameter, the ribbons can have a diameter of from about 5 mm to about 40 mm and a length of from about 20 mm to about 100 mm. More typically, the diameter can be from about 10 mm to about 30 mm and the length from about 30 mm to about 70 mm. Often, the diameter can be from about 15 mm to about 20 mm and the length from about 40 mm to about 60 mm.

The resultant frozen pellets are in a form that are free-flowing; that is, they do not clump or stick together and can easily be separated as long as they are maintained at temperatures of 20° F. or lower. Accordingly, the frozen pellets can be stored in conventional freezers and remain free flowing for easy portioning and dispersing. The frozen pellet is highly useful for preparing exact amounts of product with less waste than traditional frozen paste products. Additionally, the resultant frozen pellets are easily transported and reduce spoilage.

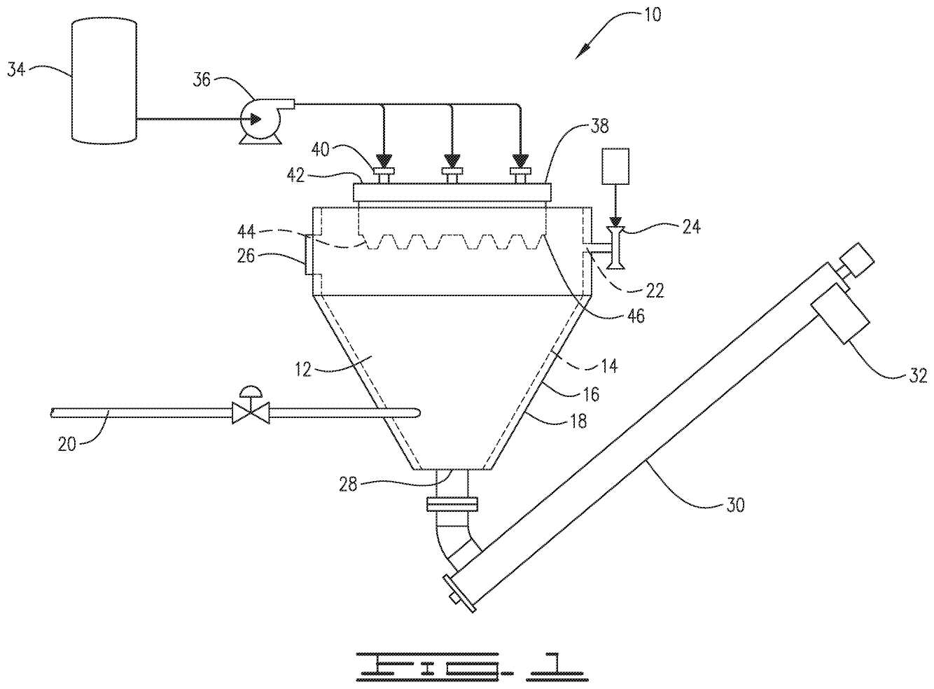

Reference is now made to FIG. 1 showing a cryogenic processor suitable for the production of a free-flowing frozen product in the form of small pellets from pastes. Cryogenic processor 10 includes a freezing chamber 12 that is most preferably in the form of a conical tank that holds a liquid refrigerant therein. Freezing chamber 12 incorporates an inner shell 14 and an outer shell 16. Insulation 18 is disposed between the inner shell 14 and outer shell 16 in order to increase the thermal efficiency of chamber 12.

Refrigerant is introduced into freezing chamber 12 through a conduit 20. The refrigerant is generally liquid nitrogen in view of its known freezing capabilities. The refrigerant is used to maintain a predetermined level of liquid refrigerant in the freezing chamber and must be added to replace refrigerant that is lost by evaporation or by other means incidental to production. Gaseous refrigerant that has evaporated from the surface of the liquid refrigerant in freezing chamber 12 primarily vents to the atmosphere through exit port 22, which cooperates with the vacuum assembly 24, which can be in the form of a venturi nozzle. An ambient air inlet port 26 can be provided to allow the introduction of air at ambient temperature to chamber 12. Both inlet port 26 and exit port 22 can include doors to adjust the flow of ambient air into chamber 12. Additionally, flow out of the chamber 12 can be changed by adjusting the vacuum applied by vacuum assembly 24. Thus, the level of gaseous refrigerant (which evaporates from the surface of the liquid refrigerant and that builds up in the top of chamber 12) can be controlled so that excessive pressure is not built up within the processor 10. Excessive buildup of gaseous refrigerant can result in freezing of the liquid composition in the enclosed feed tray 38.

The chamber 12 is chilled by the direct addition of refrigerant from a refrigerant source through conduit 20 such that chamber 12 is at a subzero temperature and paste pellets rapidly freeze as they fall through chamber 12. Generally, the subzero temperature will be −100° F. or less, and more typically −200° F. or less, −250° F. or less, or −300° F. or less. A number of different refrigerants can be utilized although liquid nitrogen is preferred. This material is readily available, relatively inexpensive and relatively inert to food products. It is also sufficiently cold to provide for relatively rapid freezing of the product. As such, it is particularly adapted for utilization in the processing of free-flowing pellets in accordance with the present disclosure.

Paste pellets can be frozen within chamber 12 similar to the process explained in U.S. Pat. No. 5,126,156, the disclosure of which is incorporated herein by reference. For example, when liquid nitrogen is utilized as the refrigerant, the temperature within the chamber 12 at and/or near the bottom is between approximately −300° to −320° F. This provides the necessary reservoir of refrigerant in the bottom of chamber 12 to quick-freeze the pellets. Paste pellets are introduced at the top of chamber 12, as further described below. As the paste pellets fall downwardly in the freezing chamber 12, they contact cold nitrogen gas rapidly vaporizing from the pool of liquid nitrogen at the bottom of chamber 12. As a result of the temperature within the range of −260° to −320° F. (for liquid N₂), rapid freezing of the paste occurs. The frozen paste pellets that are produced contain only relatively small ice crystals. The ultra-low temperature of the refrigerant limits the formation of ice crystals in the paste pellets as they are frozen. Advantageously, by reducing the overall size of the ice crystals being formed, the resulting frozen pellets retain a better, overall flavor when used in cooking.

Extraction of the frozen pellets occurs through product outlet 28 adapted at the base of the freezing chamber 12. The illustrated embodiment uses an auger delivery system 30 to carry frozen pellets from the bottom of freezing chamber 12 upward to a chute 32, where the pellets are output for packaging (not shown). As illustrated, the mouth of chute 32 is vertically above the surface level of the liquid nitrogen. Therefore, liquid nitrogen is separated from the pelleted product in the auger delivery system 30. Any trace amounts of liquid nitrogen that may be on the outer surface of the pelleted product evaporates therefrom before being expelled from chute 32. In this regard, liquid nitrogen has a very rapid evaporation rate.

When incoming refrigerant enters the freezing chamber 12 through conduit 20, a swirling or cyclonic motion of refrigerant may form in the freezing chamber 12 depending on the amount of refrigerant allowed to enter and the flow velocity of the incoming refrigerant. This cyclonic motion is not favorable to the production process because the frozen pellets awaiting extraction at the bottom of freezing chamber 12 may be swept into the swirling refrigerant and thus prevented from falling to the bottom of the freezing chamber for collection. A non-uniform pelleted product can also be produced in this turbulent environment. This unwanted cyclonic motion of the incoming refrigerant can be prevented by baffles (not shown) mounted to interior surface of inner shell 14. The baffles can extend inwardly from interior surface in the vicinity of the refrigerant inlet. Additionally, the baffles can be oriented so that their lengths are substantially vertical within the freezing chamber 12.

Feed paste from a delivery source 34 is pumped into an enclosed feed tray 38 by pump 36. Pump 36 is a positive displacement pump and increases the pressure of the feed paste for introduction into enclosed feed tray 38. For example, pump 36 can be a piston pump or a progressive cavity pump. Enclosed feed tray 38 has entrance ports 40 in top 42 and projections 44 in bottom 46. Projections 44 serve as an exit port from the enclosed feed tray 38.

Projections 44 have a central channel that is in fluid flow communication with the interior of enclosed feed tray 38 at the inner surface of bottom 46. Generally, the projections 44 are in an ordered array of rows and columns, although the present invention should not be considered as limited exclusively thereto. As can be seen, projections 44 extend downwardly from bottom 46 towards the freezing chamber 12. The central channel of projections 44 is in fluid flow communication at its lower end with freezing chamber 12. Generally, the central channel of projections 44 can have an exit orifice having a diameter of from 4 mm to 13 mm. The diameter of the central channel can be constant from the entrance orifice (at the bottom 46 of the inner surface of enclosed feed tray 38) to the exit orifice. Alternatively, the entrance orifice can have a larger diameter than the exit orifice and the central channel can taper from the entrance orifice to the exit orifice. The length of the projections can vary from being a dimple on the bottom surface of the enclosed feed tray 38 to being a short nozzle from 5 mm to 10 mm in length.

Entrance ports 40 receive a pressurized feed paste from pump 36. Generally, the feed paste is delivered to the enclosed feed tray 38 such that there is a pressure differential created between the interior of the enclosed feed tray 38 and the interior of chamber 12. Generally, the amount of the pressure differential needed will depend on the viscosity of the paste and size of the channel through projections 44. Typically, the pressure differential can be up to 15 psi depending on the viscosity of the feed paste. In some embodiments, the pressure differential can be above 15 psi; however, the trays and vessels will need to apply to applicable regulations on design. Generally, the interior of chamber 12 will be at the atmospheric pressure thus the enclosed feed tray 38 will be pressurized at above atmospheric pressure and can be up to about 15 psig, that is about 15 psi above atmospheric pressure. Broadly, the enclosed feed tray 38 is at least about 1 psig, but more typically, at least 2 psig and can be at least 5 psig or at least 10 psig. Broadly, the feed tray 38 will be no more than about 25 psig, but more typically no more than 20 psig or 15 psig or can be at no more than 12 psig. In this sense, the enclosed feed tray 38 is a pressurized feed tray.

While the above generally recites some pressures for the enclosed feed tray 38, the exact pressure of the enclosed feed tray 38 will depend on the viscosity of the paste being frozen as well as the channel diameter for projections 44. For example, if the paste comprises cream cheese and has a viscosity between 1000 Cp and 10,000 Cp—at temperatures of about 32° F. to 70° F.—and if the channel has a diameter of from 4 mm to 12 mm, then the pressure differential will typically be about 5 psig to about 15 psig to ensure an appropriate flow and/or droplet formation at the lower end of projections 44. A pressure differential in this range ensures flow of the paste through projections 44 and also prevents the paste from streaming into chamber 12 in an uncontrolled manner; thus, the paste moves through the channel in projections 44 so as to form droplets at the lower end of the projections 44 or so as to be formed into droplets, as described below. The droplets subsequently drop through the chamber and freeze during passage through chamber 12. Pump 36 should be configured to deliver paste feed to enclosed feed tray 38 at a sufficient rate to maintain the pressure differential in the aforementioned range.

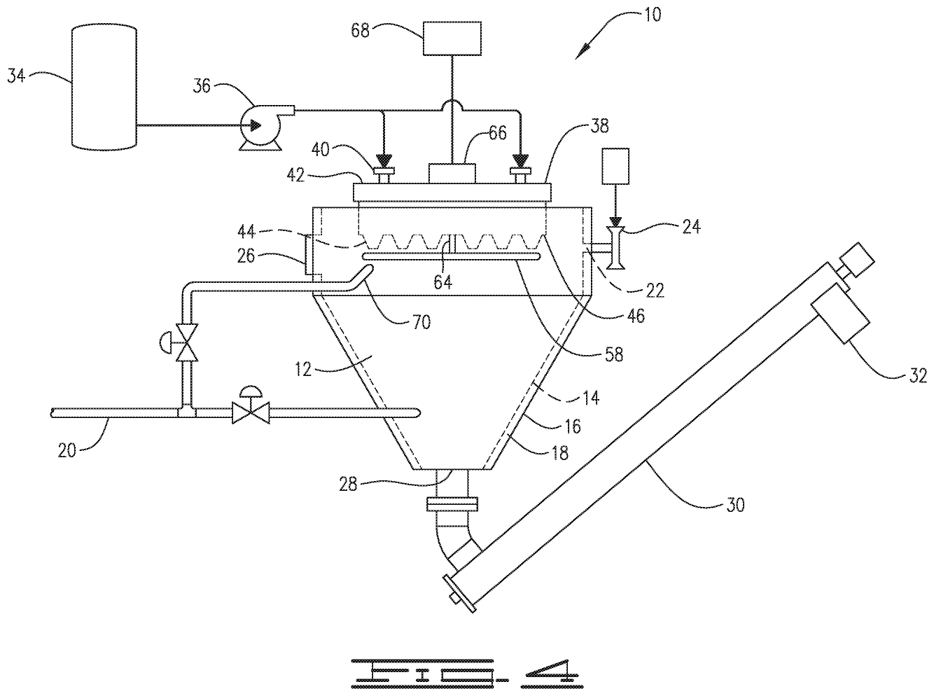

The droplets can be formed by controlling the pressure of the paste within the controlled paste. In some embodiments, the paste can be extruded with a piston pump. The piston pump is configured to pause periodically so that the paste separates into droplets at the lower end of the projections so as to form the pellets. Alternatively, a cutting mechanism can be used as described below in relation to FIGS. 4-6.

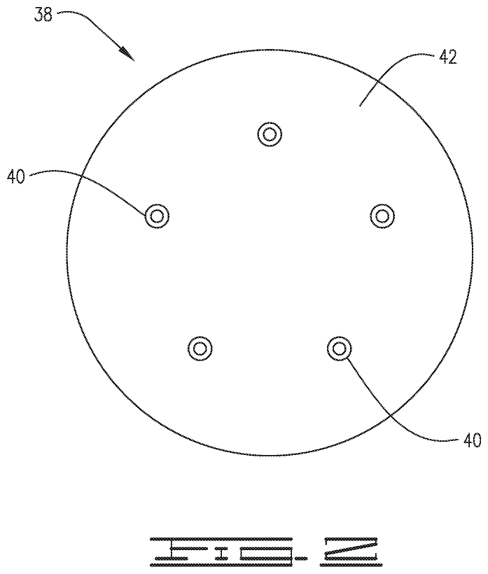

Although enclosed feed tray 38 can have a single entrance port, it is presently preferred that the tray have multiple entrance ports. As illustrated in FIG. 2, tray 38 can have two or more entrance ports 40. Each entrance port 40 can be formed or welded into the top 42. For example, each entrance port 40 can be a 1.5 inch tri-clamp orifice. Additionally, top 42 can include one or more ports (not shown) to allow introduction of a level sensor and can include a safety relief valve (not shown), which activates if to release pressure in enclosed feed tray 38 if a safe operating pressure is exceeded. In typical operation, the only exit for the feed paste would be through projections 44. If the safe operating pressure is exceeded, then pressurized gases and/or feed paste could exit through the safety relief valve.

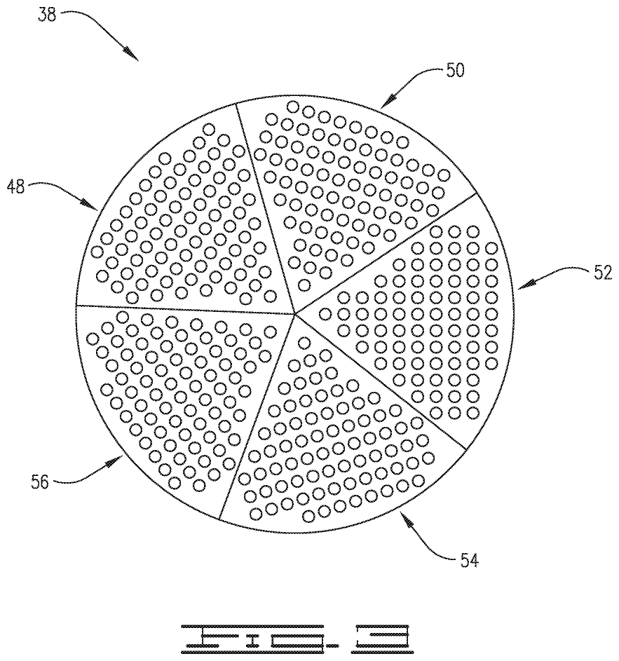

In one embodiment, the enclosed feed tray 38 is divided into two or more partitions. For example, the enclosed feed tray 38 can be divided into five partitions 48, 50, 52, 54 and 56 as shown in FIG. 3. Each separate partition receives feed paste from an associate port 40 (FIG. 2). Also, each partition can be a separate enclosed section of the feed tray such that each partition is isolated from the other partitions. That is, the paste from one partition cannot enter into one of the other partitions. Hence, the pressure and content of one partition can be independent of the others. In such embodiments, feed paste can be provided by a single delivery source 34 through a single pump 36 to each partition. Alternatively, feed paste can be provided from one or more delivery sources 34 through multiple pumps 36. This latter alternative can allow for providing different feed paste to different partitions and can allow for each partition to be at a different pressure. Thus, the pressure of a partition can be adjusted for a particular feed paste separate from the pressures of the other partitions, which may have a different feed paste requiring a different pressure.

Sensors may be incorporated to measure numerous operating values, such as pressure in each partition 48, 50, 52, 54 and 56, freezing chamber temperature, refrigerant level, etc. These sensors each provide an input signal to the control device which monitors the production process and provides control output signals to facilitate automatic production of the frozen pellets. For example, an ultrasonic sensor can be used to send 4 to 20 ma variable signal which indicates the depth of feed paste in the enclosed feed tray 38.

Turning now to FIGS. 4-6, an alternative embodiment of cryogenic processor 10 is illustrated. Depending on the viscosity of the paste and operating parameters, it may be difficult to achieve droplet formation at the lower end of projections 44 by pressure regulation alone. In such circumstances, cryogenic processor 10 may include a cutter 58 operatively associated with the lower end of projections 44 so as to be able to cut or scrape ribbons 60 of paste 62, which stream out of the lower end of projections 44. Cutter 58 can be a variety of configurations depending on the viscosity and separation qualities of the feed paste. For example, cutter 58 can have a narrow flat configuration, or alternatively, be a thin wire. The thin wire reduces the resistance of the feed paste over the cutter assembly.

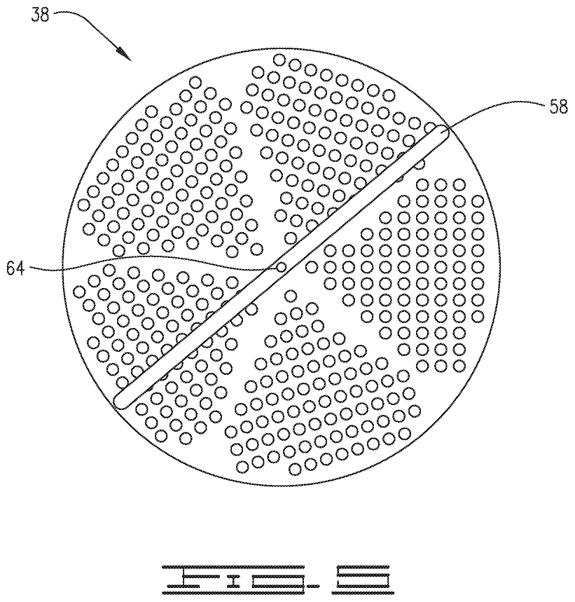

As best seen from FIGS. 4 and 5, cutter 58 has a propeller configuration in relation to the bottom 46 of enclosed feed tray 38. Cutter 58 is mounted on an axle 64 which extends through the center of enclosed feed tray 38. Enclosed feed tray 38 can have a vertical partition (not shown), which isolates axle 64 from any paste in enclosed feed tray 38 so that paste does not contact the axle or leak out around the axle. The vertical partition will generally be a cylindrical sleeve extending from the bottom 46 to top 42 of enclosed feed tray 38. A motor 66, which receives power from a power source 68, can rotate the axle 64.

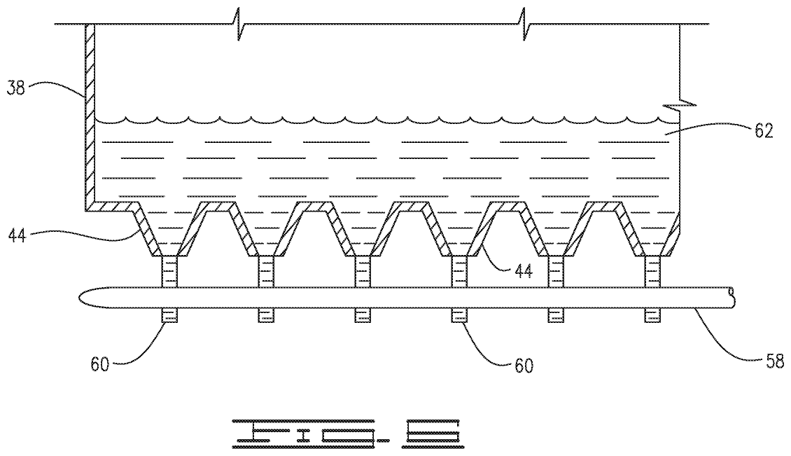

As can be seen from FIGS. 5 and 6, cutter 58 is rotated by axle 64 so that cutter 58 spins in a circle contacting ribbons 60 as they stream out of projections 44. When cutter 58 contacts a ribbon 60, it cuts or breaks the ribbon forming particles or droplets of paste 62, which fall to the bottom of chamber 12 and freeze as they drop. In order to prevent gumming of cutter 58, i.e. deposits of paste on cutter 58, cutter 58 can be kept at a subfreezing temperature. For example, operation of cryogenic processor 10 can include a precooling step in which liquid nitrogen is introduced into chamber 12 to cool cutter 58 and paste is introduced into enclosed feed tray 38 only after cutter 58 has reached a suitable operation temperature. Optionally, a liquid nitrogen sprayer 70 can be used to spray liquid nitrogen directly onto cutter 58 so as to reduce its temperature to a suitable subfreezing temperature prior to introduction of paste to enclosed feed tray 38. Additionally, sprayer 70 can be used to maintain cutter 58 at an appropriate temperature during freezing of the paste in chamber 12.

While apparatuses and methods are described in terms of “comprising,” “containing,” or “including” various components or steps, the apparatuses and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a to b”) disclosed herein is to be understood to set forth every number and range encompassed within the broader range of values. Additionally, where the term “about” is used in relation to a range, it generally means plus or minus half the last significant figure of the range value, unless context indicates another definition of “about” applies.

Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A process for cryogenic freezing a paste into a frozen pelletized form, the process comprising:
introducing the paste into an enclosed feed tray, wherein the paste is introduced at a pressure above atmospheric pressure and remains above atmospheric pressure while in the enclosed feed tray, wherein the paste has a viscosity above about 200 Cp;
extruding the paste out of the enclosed feed tray through a plurality of projections;
cutting the paste as the paste is extruded out of the enclosed feed tray by a cutter operatively associated with the projections so as to produce a plurality of pellets having a diameter greater than 5 mm to about 50 mm; and
passing the pellets through a cryogenic chamber to thus freeze the pellets at subzero temperatures to produce frozen pellets.

2. The process of claim 1, wherein the pressure is at least 1 psig.

3. The process of claim 1, wherein the pressure is at least 5 psig.

4. The process of claim 1, wherein the pellets have a diameter from about 10 mm to about 30 mm.

5. The process of claim 1, wherein the enclosed feed tray is divided into a plurality of partitions, which are isolated so that paste does not flow between partitions, and introducing the paste into an enclosed feed tray further comprises introducing a first paste into at least one of the partitions and a second paste into a least one of the other partitions.

6. The process of claim 1, wherein the paste has a viscosity above 500 Cp.

7. The process of claim 1, wherein the paste has a viscosity from 1000 Cp to 10,000 Cp and the pressure is from 5 psig to 15 psig.

8. The process of claim 7, wherein the enclosed feed tray is divided into a plurality of partitions, which are isolated so that paste does not flow between partitions, the paste comprises a first paste and a second paste, and introducing the paste into an enclosed feed tray further comprises introducing the first paste into at least one of the partitions and the second paste into a least one of the other partitions.

9. The process of claim 8, wherein the thus produced pellets comprise a first portion of the pellets consist essentially of the first paste and a second portion of the pellets consist essentially of the second paste.

10. A system of cryogenic freezing a paste into a frozen pelletized form, the system comprising:
an enclosed feed tray pressurized above atmospheric pressure, the enclosed feed tray having at least one entrance port through which the paste is introduced into the enclosed feed tray at a pressure above atmospheric pressure, and a plurality of projections through which the paste is extruded out of the enclosed feed tray;
a cutter operatively associated with the projections so as to cut paste extruded through the projections thus producing the pellets, wherein the projections and cutter are configured to produce pellets having a diameter greater than 5 mm to about 50 mm; and
a cryogenic freezing chamber configured to receive the paste extruded from the plurality of projections, wherein the paste is introduced into the cryogenic freezing chamber as a plurality of pellets and the cryogenic freezing chamber is configured to cryogenically freeze the pellets such that the pellets are frozen to subzero temperatures as the pellets fall through the cryogenic freezing chamber.

11. The system of claim 10, wherein the pellets have a diameter from about 10 mm to about 30 mm.

12. The system of claim 10, further comprising:
a source of paste; and
a pump in fluid flow communication with the source and with the entrance port so as to introduce paste from the source to the enclosed feed tray at the pressure above atmospheric pressure.

13. The system of claim 10, wherein the enclosed feed tray is divided into two or more partitions which are isolated so that paste is not exchanged between partitions, and the enclosed feed tray further comprises two or more entrance ports such that there is at least one entrance port associated with each partition.

14. The system of claim 13, wherein the paste comprises at least a first paste and a second paste, and the system is configured so that the first paste is provided to at least one of the partitions and the second paste is provided to at least one of the other partitions.

15. The system of claim 14, wherein a first portion of the pellets consist essentially of the first paste and a second portion of the pellets consist essentially of the second paste.

16. A paste product comprising a free-flowing frozen pellet produced from a paste having a viscosity from 200 Cp to 30,000 Cp at processing temperatures, wherein the paste has been pelletized to a diameter of greater than about 5 mm to about 50 mm, and the paste is frozen at temperatures of less than −100° F. to produce the free-flowing frozen pellet.

17. The paste product of claim 16, wherein the paste is a food product paste and the processing temperatures are from about 32° F. to about 70° F.

18. The paste product of claim 17, wherein the viscosity is from 1000 Cp To 10,000 Cp at processing temperatures from 32° F. to about 45° F.

19. The paste product of claim 18, wherein the frozen pellets have a diameter from about 10 mm to about 30 mm.
